(19) United States
(12) Patent Application Publication
(10) Pub. No.: US 2018/0096113 A1
(43) Pub. Date: Apr. 5, 2018

(54) Content Protection for a Screen Sharing Experience

(71) Applicant: Microsoft Technology Licensing, LLC, Redmond, WA (US)

(72) Inventors: Amer Aref Hassan, Kirkland, WA (US); William George Verthein, Sammamish, WA (US); Jeffrey Alan Coffin, Los Gatos, CA (US); Gareth L. E. Bridges, Redmond, WA (US)

(73) Assignee: Microsoft Technology Licensing, LLC, Redmond, WA (US)

(21) Appl. No.: 15/284,291

(22) Filed: Oct. 3, 2016

(51) Int. Cl. G06F 21/10; G06F 3/0488; G06F 3/0484; G06F 3/0481; G06F 21/62

(52) U.S. Cl. CPC G06F 21/10; G06F 3/04883; G06F 3/04847; G06F 2221/0713; G06F 21/6245; G06F 2203/04803; G06F 3/04817

(57) ABSTRACT

Techniques for content protection for a screen sharing experience are described. According to various embodiments, a user that is sharing their screen with other devices as part of a screen sharing experience can protect a portion of the screen from being shared by designating the portion as sharing protected. Thus, the identified portion of the user's screen is not shared while other portions are shared as part of the screen sharing experience. According to one or more embodiments, digital rights management (DRM) techniques are employed to enforce sharing protection. According to one or more embodiments, a user can be designated as sharing privileged such that the user is permitted to receive content that is designated as sharing protected as part of a screen sharing experience.

### BACKGROUND

Modern communication systems have an array of capabilities, including integration of various communication modalities with different services. For example, instant messaging, voice/video communications, data/application sharing, white-boarding, and other forms of communication may be combined with presence and availability information for subscribers. Such systems may provide subscribers with the enhanced capabilities such as providing instructions to callers for various status categories, alternate contacts, calendar information, and comparable features. Furthermore, collaboration systems enabling users to share and collaborate in creating and modifying various types of documents and content may be integrated with multimodal communication systems providing different kinds of communication and collaboration capabilities. Such integrated systems are sometimes referred to as Unified Communication and Collaboration (UC&C) systems.

While UC&C systems provide for increased flexibility in communications, they also present a number of implementation challenges. For instance, a user may wish to share screen content to different devices engaged in UC&C communication. The user, however, may wish to protect some screen content from being shared. Enabling concurrent screen sharing and content protection presents a number of implementation challenges.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for content protection for a screen sharing experience are described. In at least some embodiments, a screen sharing experience involves a user sharing portions of their display screen with other users as part of a communication session. According to various embodiments, a user that is sharing their screen with other devices as part of a screen sharing experience can protect a portion of the screen from being shared by designating the portion as sharing protected. Thus, the identified portion of the user's screen is not shared while other portions are shared as part of the screen sharing experience. According to one or more embodiments, digital rights management (DRM) techniques are employed to enforce sharing protection. According to one or more embodiments, a user can be designated as sharing privileged such that the user is permitted to receive content that is designated as sharing protected as part of a screen sharing experience.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 depicts an example implementation scenario for content protection for a screen sharing experience in accordance with one or more embodiments.

FIG. 3 depicts an example implementation scenario for designating a sharing protected region in accordance with one or more embodiments.

FIG. 4 depicts an example implementation scenario for designating a sharing protected region in accordance with one or more embodiments.

FIG. 5 depicts an example implementation scenario for designating a user set that is permitted to view a sharing protected region in accordance with one or more embodiments.

FIG. 6 is a flow diagram that describes steps in a method for designating a sharing protected region in accordance with one or more embodiments.

FIG. 7 is a flow diagram that describes steps in a method for rescinding sharing protection in accordance with one or more embodiments.

FIG. 8 is a flow diagram that describes steps in a method for designating a user as sharing privileged in accordance with one or more embodiments.

FIG. 9 illustrates an example system and computing device as described with reference to FIG. 1, which are configured to implement embodiments of techniques described herein.

### DETAILED DESCRIPTION

Techniques for content protection for a screen sharing experience are described. In at least some implementations, a screen sharing experience involves a user sharing portions of their display screen with other users as part of a communication session. A communication session, for instance, refers to a real-time exchange of communication media between different communication endpoints. Examples of a communication session include a Voice over Internet Protocol (VoIP) call, a video call, text messaging, a file transfer, content sharing, and/or combinations thereof. In at least one implementation, a communication session represents a Unified Communication and Collaboration (UC&C) session.

According to various implementations, a user that is sharing their screen with other devices as part of a screen sharing experience wishes to protect a portion of the screen from being shared. For instance, a portion of their screen may be displaying sensitive and/or personal information that the user doesn't wish to share. Accordingly, the user invokes a sharing protect functionality to enables the user to identify a portion of their screen that is not to be shared with the other devices. The user, for instance, can draw a protection zone around a portion of their screen that they wish to sharing protect. Other ways of designating a particular portion of a display as sharing protected are described below. Thus, the identified portion of the user's screen is not shared while other portions are shared as part of the screen sharing experience.

According to one or more implementations, digital rights management (DRM) techniques are employed to enforce sharing protection. For instance, when a user identifies a particular portion of a screen to be sharing protected, the portion of the screen is mapped in a DRM library. Thus, a DRM policy is defined for the particular portion of the screen, e.g., content displayed in the particular portion. When other portions of the screen are shared during a screen sharing experience, the DRM policy is enforced based on one or more conditions to ascertain whether content from the particular portion of the screen is permitted to be shared.

According to one or more implementations, a user can be designated as sharing privileged such that the user is permitted to receive content that is designated as sharing protected as part of a screen sharing experience. For instance, a sharing user that specifies a portion of their display screen as sharing protected as part of a screen sharing experience can identify a participant in the screen sharing experience as sharing privileged. Thus, a device associated with the privileged participant receives content from the sharing protected portion of the screen, while other non-privileged participants in the screen sharing experience do not receive the content. In this way, a user can protect certain screen content from general sharing, while designating a set of privileged users that are permitted to receive the content.

Accordingly, techniques for content protection for a screen sharing experience described herein enhance the ability for users to protect sensitive content and data during a screen sharing experience, thus improving data security for sensitive user data and preventing undesired exposure of sensitive user content. The described techniques also improve computing device performance during a screen sharing experience by leveraging DRM techniques to protect sharing protected content.

In the following discussion, an example environment is first described that is operable to employ techniques described herein. Next, a section entitled “Example Implementation Scenarios” describes some example implementation scenarios in accordance with one or more embodiments. Following this, a section entitled “Example Procedures” describes some example procedures in accordance with one or more embodiments. Finally, a section entitled “Example System and Device” describes an example system and device that are operable to employ techniques discussed herein in accordance with one or more embodiments.

Having presented an overview of example implementations in accordance with one or more embodiments, consider now an example environment in which example implementations may by employed.

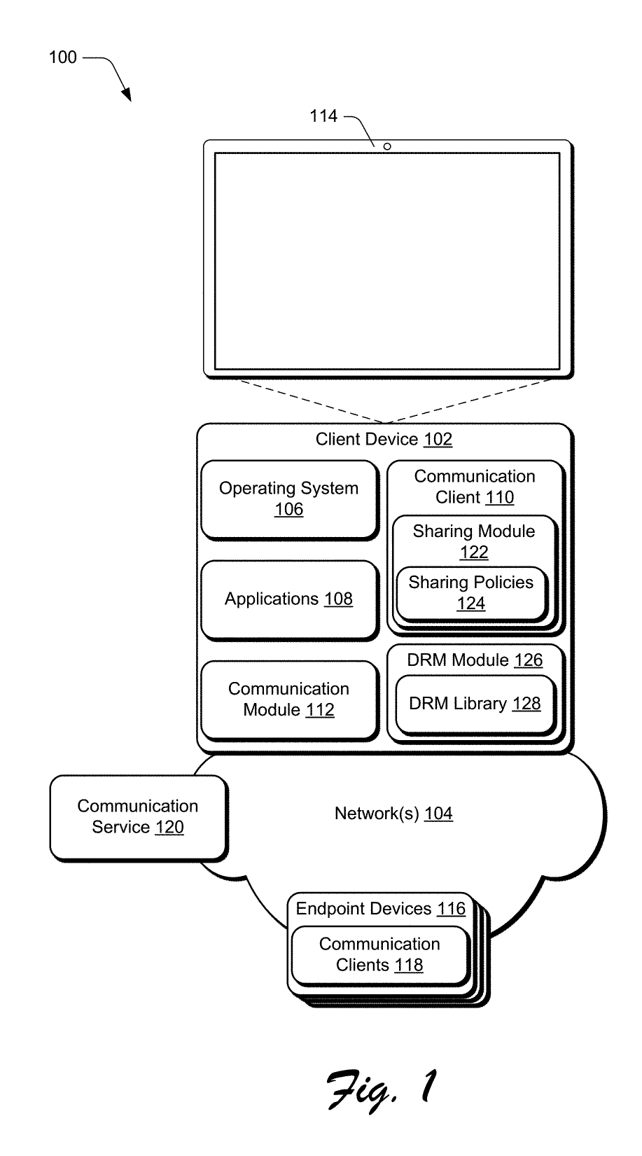

FIG. 1 is an illustration of an environment 100 in an example implementation that is operable to employ techniques for content protection for a screen sharing experience described herein. Generally, the environment 100 includes various devices, services, and networks that enable communication via a variety of different modalities. For instance, the environment 100 includes a client device 102 connected to a network 104. The client device 102 may be configured in a variety of ways, such as a traditional computer (e.g., a desktop personal computer, laptop computer, and so on), a mobile station, an entertainment appliance, a smartphone, a wearable device, a netbook, a game console, a handheld device (e.g., a tablet), and so forth.

The network 104 is representative of a network that provides the client device 102 with connectivity to various networks and/or services, such as the Internet. The network 104 may provide the client device 102 with connectivity via a variety of different connectivity technologies, such as broadband cable, digital subscriber line (DSL), wireless cellular, wireless data connectivity (e.g., WiFi™), T-carrier (e.g., T1), Ethernet, and so forth. In at least some implementations, the network 104 represents different interconnected wired and wireless networks.

The client device 102 includes a variety of different functionalities that enable various activities and tasks to be performed. For instance, the client device 102 includes an operating system 106, applications 108, a communication client 110, and a communication module 112. Generally, the operating system 106 is representative of functionality for abstracting various system components of the client device 102, such as hardware, kernel-level modules and services, and so forth. The operating system 106, for instance, can abstract various components of the client device 102 to the applications 108 to enable interaction between the components and the applications 108.

The applications 108 represent functionalities for performing different tasks via the client device 102. Examples of the applications 108 include a word processing application, a spreadsheet application, a web browser, a gaming application, and so forth. The applications 108 may be installed locally on the client device 102 to be executed via a local runtime environment, and/or may represent portals to remote functionality, such as cloud-based services, web apps, and so forth. Thus, the applications 108 may take a variety of forms, such as locally-executed code, portals to remotely hosted services, and so forth.

The communication client 110 is representative of functionality to enable different forms of communication via the client device 102. Examples of the communication client 110 include a voice communication application (e.g., a VoIP client), a video communication application, a messaging application, a content sharing application, a unified communication & collaboration (UC&C) application, and combinations thereof. The communication client 110, for instance, enables different communication modalities to be combined to provide diverse communication scenarios.

The communication module 112 is representative of functionality for enabling the client device 102 to communicate data over wired and/or wireless connections. For instance, the communication module 112 represents hardware and logic for data communication via a variety of different wired and/or wireless technologies and protocols.

The client device 102 further includes a display device 114, which represents functionality for visual output for the client device 102. Additionally, the display device 114 represents functionality for receiving various types of input, such as touch input, pen input, and so forth.

The environment 100 further includes endpoint devices 116, which are representative of devices and/or functionalities with which the client device 102 may communicate. In at least some implementations, the endpoint devices 116 represent end-user devices such as discussed with reference to the client device 102. The endpoint devices 116 include communication clients 118, which are representative of functionalities to enable different forms of communication via the endpoint devices 116. The communication clients 118, for example, represent different instances of the communication client 110. For purposes of discussion herein, reference is made to an endpoint device 116 and a communication client 118, which represent instances of the endpoint devices 116 and the communication clients 118, respectively.

In at least some implementations, the communication clients 110, 118 represent interfaces to a communication service 120. Generally, the communication service 120 is representative of a service to perform various tasks for management of communication between the client device 102 and the endpoint device 116. The communication service 120, for instance, can manage initiation, moderation, and termination of communication sessions between the communication clients 110, 118.

The communication service 120 maintains a presence across many different networks and can be implemented according to a variety of different architectures, such as a cloud-based service, a distributed service, a web-based service, and so forth. Examples of the communication service 120 include a VoIP service, an online conferencing service, a UC&C service, and so forth.

The communication client 110 further includes a sharing module 122, which is representative of functionality for performing various aspects of techniques for content protection for a screen sharing experience discussed herein. Various attributes and operational aspects of the sharing module 122 are detailed below. The sharing module 122 maintains sharing policies 124, which are representative of different sets of data that specify permissions and criteria for sharing content between the client device 102 and the endpoint devices 116. The sharing policies 124, for instance, specify which regions of the display device 114 may be shared with the endpoint devices 116, and which regions of the display device 114 may not be shared with the endpoint devices 116. Alternatively or additionally, the sharing policies 124 are content and/or application-specific. For example, the sharing policies 124 can specify certain types of content that are permitted to be shared with the endpoint devices 116, and other types of content that are not permitted to be shared with the endpoint devices 116. Further, the sharing policies 124 can specify that an application window for a particular application 108 is permitted to be shared, whereas an application window for a different application 108 is not permitted to be shared. Generally, the sharing policies 124 can be configured in various ways, such as via default settings specified by an application developer, end user-specified settings, and so forth.

In at least some implementations, the sharing policies 124 include DRM policies that specify whether sharing protected content is permitted to be shared. For instance, a particular sharing policy 124 can specify that under certain conditions (e.g., in a particular geographic and/or network location), sharing protected content is permitted to be shared, whereas under different conditions (e.g., in a different location), the sharing protected content is not permitted to be shared.

While the sharing module 122 and the sharing policies 124 are depicted as being implemented on the client device 102, it is to be appreciated that in some additional or alternative implementations, functionality of the sharing module 122 and/or the sharing policies 124 may be partially or wholly implemented via a network-based service, such as the communication service 120. For instance, the communication service 120 may perform various aspects of techniques for content protection for a screen sharing experience described herein.

The client device 102 further includes a digital rights management (DRM) module 126, which includes a DRM library 128. The DRM module 126 is representative of functionality for determining and enforcing various content protections for content that resides on and/or is accessible to the client device 102. The DRM module 126, for instance, can apply DRM protections that are specified for particular instances and/or types of content. The DRM library 128 represents a data catalog that specifies content protections (e.g., DRM protections) for particular instances and/or types of content. For example, the DRM library identifies particular instances of content, and various DRM protections for the content, such as devices on which the content may or may not be consumed, identities of users that are permitted to consume the content, a number of times the content may be consumed, and so forth. As further detailed below, the DRM module 126 may be leveraged to prevent certain types of content that is displayed on the display device 114 from being shared to the endpoint devices 116 and/or particular instances of the endpoint devices 116.

Having described an example environment in which the techniques described herein may operate, consider now a discussion of an example implementation scenario for content protection for a screen sharing experience in accordance with one or more embodiments.

The following section describes some example implementation scenarios for content protection for a screen sharing experience in accordance with one or more implementations. The implementation scenarios may be implemented in the environment 100 discussed above, and/or any other suitable environment.

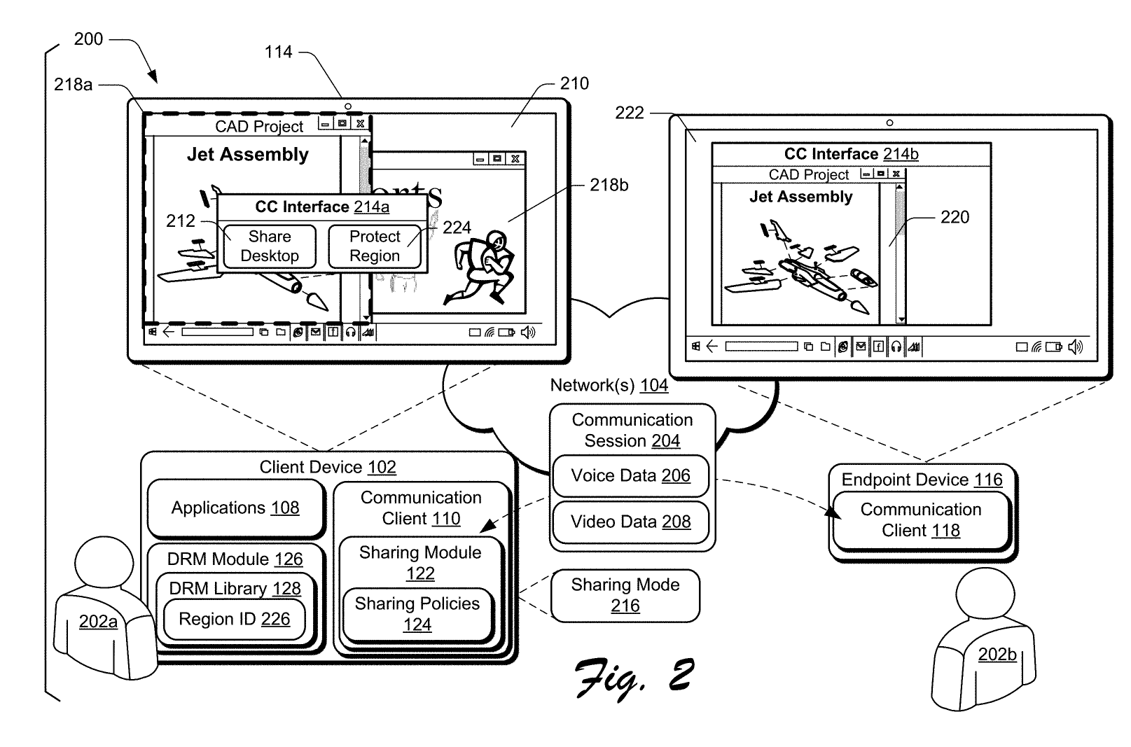

FIG. 2 depicts an example implementation scenario 200 for sharing screen content during a communication session in accordance with one or more implementations. The scenario 200 includes various entities and components introduced above with reference to the environment 100.

In the scenario 200, a user 202a of the client device 102 is engaged in a communication session 204 with a user 202b of an endpoint device 116. Generally, the communication session 204 represents a real-time exchange of different communication media between the client device 102 and the endpoint device 116, such as audio, video, files, media content, and/or combinations thereof. In this particular example, the communication session 204 involves a real-time exchange of voice data 206 and video data 208 between the client device 102 and the endpoint device 116 over the network 104.

As part of the communication session 204, the user 202a performs an action to share a portion of a desktop 210 of the display device 114 with the user 202b. Generally, the desktop 210 represents a portion of the display device 114 in which different interfaces and controls for applications, tasks, system operations, and so forth, are displayed. For instance, the user 202a selects a share control 212 from a communication client (“CC”) interface 214a. Generally, the CC interface 214a represents an interface for the communication client 110 that enables the user 202a to perform various actions and view status information pertaining to the communication session 204. Selection of the share control 212 activates a sharing mode 216 that causes at least a portion of the desktop 210 to be shared with the endpoint device 116.

Accordingly, responsive to the user action to activate the sharing mode 216, a region 218a of the desktop 210 is shared with the endpoint 116. The user action to share the desktop 210 causes a visual representation 220 of the region 218a to be presented within a CC interface 214b displayed on a display 222 of the endpoint device 116. The visual representation 220, for instance, represents a live copy of the region 218a that is communicated from the client device 102 to the endpoint device 116 as part of the video data 208. Generally, the CC interface 214b represents a GUI of the communication client 118.

Notice that while the region 218a is shared to the endpoint device 116, a different region 218b of the desktop 210 is not shared to the endpoint device 116. According to techniques for content protection for a screen sharing experience described herein, the region 218b is designated as a protected region that is not to be shared with the endpoint device 116. Generally, the region 218b can be designated as a protected region in various ways, such as by a user action that identifies the region 218b as a protected region. For instance, the user 202a selects a protect control 224 from the CC interface 214a, which activates a sharing protect mode that enables the region 218b to be designated as sharing protected. Examples of different ways of designating protected regions of a display area are discussed below.

To enable the region 218b to be protected from sharing to the endpoint device 116, the communication client 110a interfaces with the DRM module 126 to cause the region 218b to be mapped within the DRM library 128. For instance, the sharing module 122 passes a region identifier (“ID”) 226 for the region 218b to the DRM module 126, and the DRM module 126 records the region ID 226 in the DRM library 128. Generally, the region ID 226 may be implemented in various ways, such as pixel coordinates that define the region 218b, an application identifier for an application 108 that presents content within the region 218b, a file identifier for content presented within the region 218b, and so forth.

Accordingly, the DRM library 128 is leveraged to enforce protection of the region 218b from sharing. For instance, when the user 202a performs an action to share the desktop 210, the sharing module 122 calls the DRM module 126 to determine whether any regions of the desktop 210 are sharing protected. The DRM module 126 retrieves the region ID 226 from the DRM library 128, and returns the region ID 226 to the sharing module 122. Accordingly, the sharing module 122 determines based on the region ID 226 that the region 218b is not to be shared to the endpoint 116, and thus prevents the region 218b from being shared to the endpoint 116.

In this way, different regions of a display area (e.g., a desktop) can be defined as sharing restricted to enable some portions of a display to be shared, and other portions to be protected from sharing. Generally, content can be designated as sharing protected dynamically and while the communication session 204 is in progress. For instance, the user 202a can perform actions to cause sharing protection for the region 218b to be applied and then later removed and while the communication session 204 is in progress. Alternatively or additionally, certain content can be persistently designated as sharing protected such that sharing protection is automatically applied across multiple separate communication sessions. Persistent sharing protection, for example, can be applied based on an application ID, a content type, a specific portion of the desktop 210, and so forth.

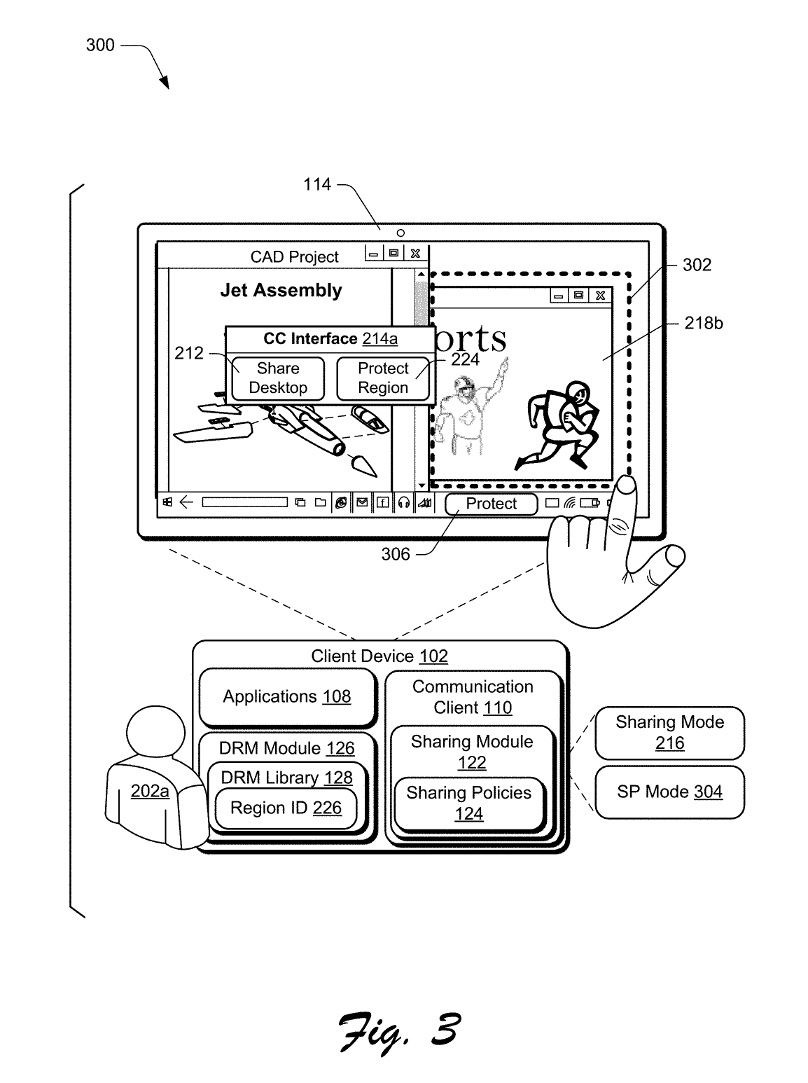

FIG. 3 depicts an example implementation scenario 300 for designating a sharing protected region in accordance with one or more implementations. The scenario 300 includes various entities and components introduced above with reference to the environment 100. The scenario 300, for instance, may be implemented in conjunction with the scenario 200 described above.

In the scenario 300, the client device 102 is in the sharing mode 216. Further, the user 202a designates the region 218b as a sharing protected region such the region 218b is not shared with another device while the sharing mode 216 is active, such as described above in the scenario 200. The user 202a, for instance, uses touch input to the display device 114 to draw a protect zone 302 around the region 218b. Others types of input may also be used to draw the protect zone 302, such as input using a mouse and cursor, touchless gesture input, stylus input, and so forth. In this particular example, the protect zone 302 is visually indicated via a dashed line to provide a visual affordance of a portion of the display device 114 that is designated as sharing protected.

In at least one implementation, the user 202a activates a sharing protect (“SP”) mode 304 prior to drawing the protect zone 302. Alternatively or additionally, the user 202a draws the protect zone 302 and then subsequently activates the SP mode 304. In one particular example, the SP mode 304 is activated by selecting a sharing protect (“protect”) control 306. Generally, the SP mode 304 allows a protect zone to be drawn around any arbitrary portion of the display device 306, and content within the protect zone will be designated as sharing protected.

Further to the scenario 300, drawing the protect zone 302 causes the portion of the display device 114 within the protect zone 302 to be mapped to the DRM library 128. The region ID 226, for instance, is added to the DRM library 128 in response to the user 202a drawing the protect zone 302. As discussed above, the region ID 226 identifies portions of the display device 114 that are sharing protected, such as the region 218b.

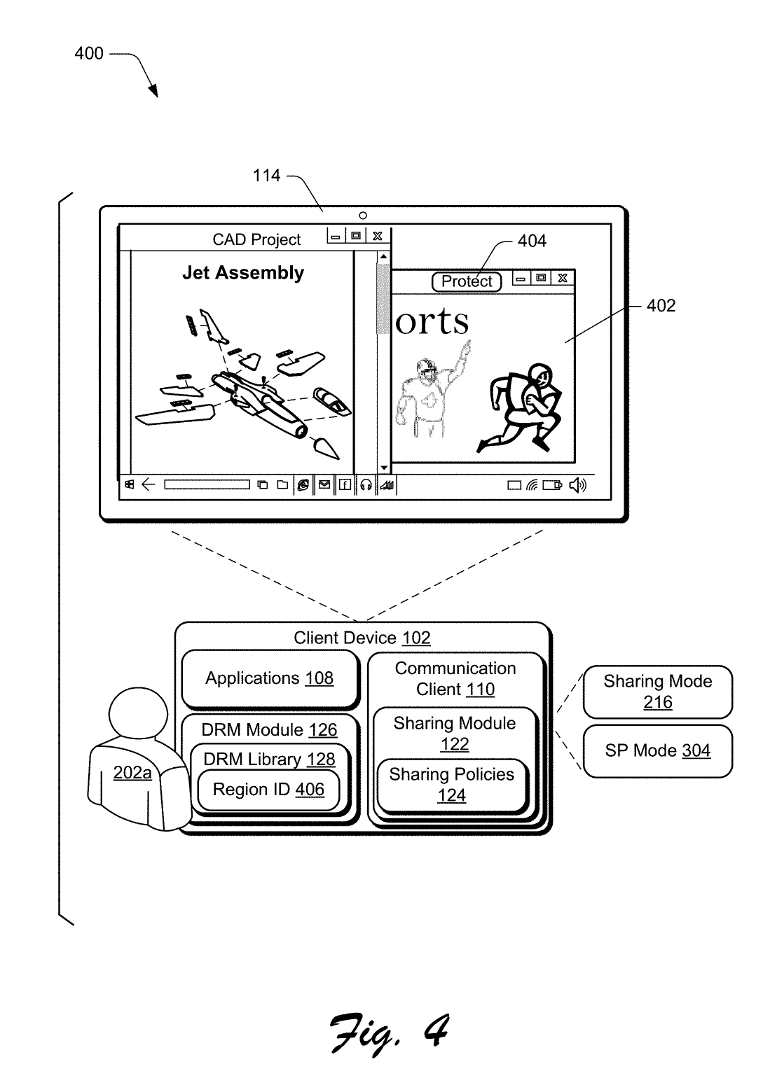

FIG. 4 depicts an example implementation scenario 400 for designating a sharing protected region in accordance with one or more implementations. The scenario 400 includes various entities and components introduced above with reference to the environment 100. The scenario 400, for instance, may be implemented in conjunction with the scenarios 200, 300 described above.

In the scenario 400, the client device 102 is in the sharing mode 216, such as described above. Further, a GUI 402 includes a protect control 404. The GUI 402, for instance, represents a GUI for a particular application 108. According to implementations discussed herein, the protect control 404 is selectable to invoke the SP mode 304 for the GUI 402. For instance, in response to the user 202a selecting the protect control 404, the SP mode 304 is invoked for the GUI 402. Accordingly, the user 202a can move (e.g., drag) the GUI 402 within the display device 114, and the GUI 402 will remain sharing protected. Thus, the SP mode 304 can be bound to a particular instance of content (e.g., the GUI 402) such that the content remains sharing protected wherever the content may be displayed.

Generally, invoking the SP mode 304 for the GUI 402 causes the GUI 402 to be mapped to the DRM library 128 via a region ID 406. The region ID 406, for instance, identifies the GUI 402 and/or the application 108 that is represented by the GUI 402. Thus, the region ID 406 is leveraged to enforce sharing protection for the GUI 402 such that the GUI 402 is not shared to other devices when content from other regions of the display device 114 are shared.

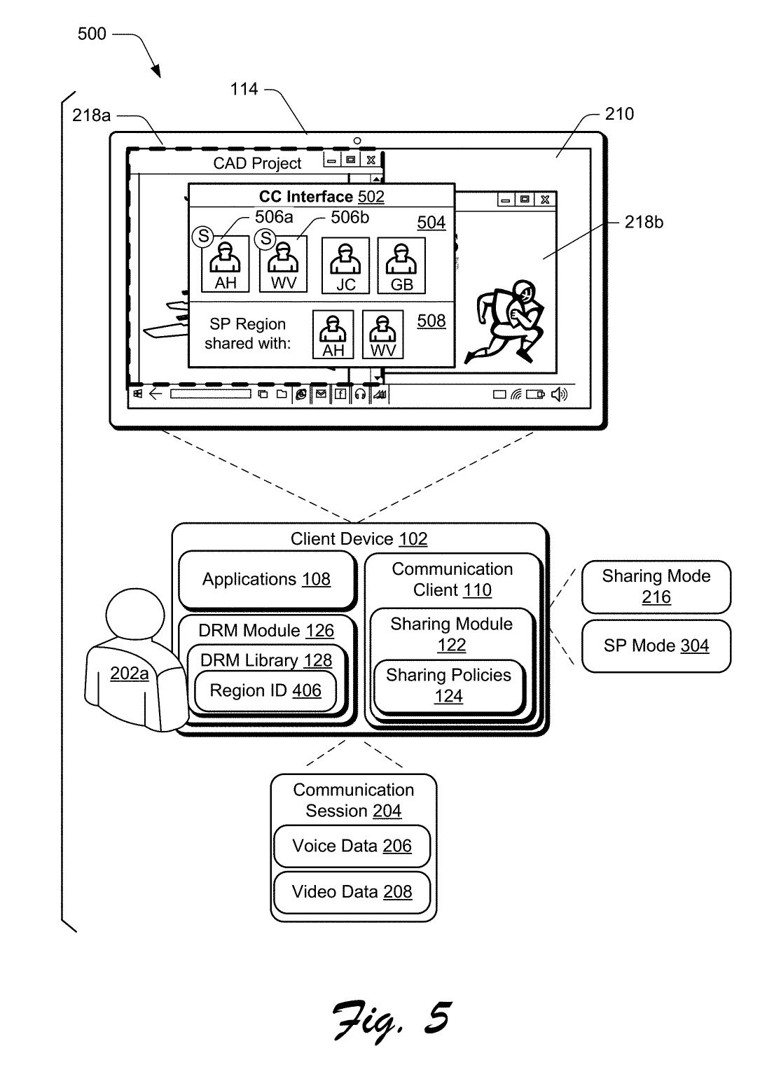

FIG. 5 depicts an example implementation scenario 500 for designating a user set that is permitted to view a sharing protected region in accordance with one or more implementations. The scenario 500 includes various entities and components introduced above with reference to the environment 100. The scenario 500, for instance, may be implemented in conjunction with the scenarios 200-400 described above.

In the scenario 500, the user 202a is participating in the communication session 204 introduced above and the sharing mode 216 is active such that a portion of the desktop 210 is shared with other devices participating in the communication session 204. Further, the region 218b is designated as sharing protected, such as described above.

Further to the scenario 500, a CC interface 502 is displayed on the display device 114. Generally, the CC interface 502 represents an interface for the communication client 110 that enables the user 202a to perform various actions and view various information pertaining to the communication session 204. In this particular example, the CC interface 502 includes a participant region 504 that identifies different users that are connected to and participating in the communication session 204. For instance, the participant region 504 is populated with visual icons that each represent a different user that is connected to the communication session 204.

As discussed above, in at least some implementations, when a user designates a particular region of a display area as sharing protected, the region is not shared with other participants in a communication session when other regions of the display area are shared as part of the sharing mode 216. However, implementations discussed herein enable a user to prevent a particular region from being shared with some users, while allowing the region to be shared with other users. For instance, the user 202b can identify certain users that are permitted to view a region that has been designated as sharing protected.

In the CC interface 502, a user icon 506a and a user icon 506b in the participant region 504 are visually annotated to indicate that the users represented by the respective icons 506a, 506b are designated as privileged to view sharing protected content. The icons 506a, 506b, for instance, are annotated with the letter “S” to indicate that the respective users are sharing privileged.

Generally, the user 202a can designate the users as sharing privileged in various ways. For instance, the user 202b can select the individual icons 506a, 506b, such as via a right click with a mouse, a press and hold touch gesture, a touchless hand gesture, and so forth. In response to the selection, the user 202b can be presented with a selectable option that enables the icons 506a, 506b to be designated as privileged.

Alternatively or additionally, the user 202a can drag the icons 506a, 506b from the participant region 504 into a privileged region 508 of the CC interface 502, which causes the respective users to be designated as sharing privileged. The privileged region 508, for instance, is populated with the icons 506a, 506b to indicate that the respective users are designated as sharing privileged such that content that is designated as sharing protected will be shared with the users.

Further to the scenario 500, in response to users represented by the icons 506a, 506b being designated as sharing privileged, the region 218b is shared to the user's devices even though the region 218b is designated as sharing protected. Thus, the region 218b is not shared with other users that are participating in the communication session 204 but are not designated as sharing privileged.

If the user 202a wishes to rescind sharing privilege for a particular user, the user 202a can perform an action to do so. For instance, the user 202a can select an individual icon 506a, 506b and be presented with an option to discontinue sharing privilege for the respective user. If the user 202a selects the options, sharing privilege for the user will be deactivated such that content that is designated as sharing privileged will no longer be shared with the user. Alternatively or additionally, the user 202a can drag an icon 506a, 506b from the privileged region 508 to the participant region 504, which causes sharing privilege for the respective user to be deactivated.

In at least some implementations, users can be designated as privileged and non-privileged dynamically, such as while the communication session 204 is in progress. For instance, consider that the user has designated the region 218b as sharing protected, such as described above. Further, while the communication session 204 is in progress, the user 202a wants to temporarily share the region 218b with a subset of participants in the communication session 204. Accordingly, while the communication session 204 is ongoing, the user can perform an action to designate users represented by the icons 506a, 506b as sharing privileged. In response, the region 218b will transition from being sharing protected from the users, to being shared with the users such that the users can view the region 218b at their respective devices while the region 218b remains sharing protected to other non-privileged users that are participating in the communication session. If the user 202a later decides while the communication session 204 is in progress to sharing protect the region 218b from the users, the user 202a can rescind sharing privilege from the users, such as described above. Thus, implementations for content protection for a screen sharing experience enable sharing protected regions to be temporarily shared with different users while a communication session is in progress.

Having discussed some example implementation scenarios, consider now a discussion of some example procedures in accordance with one or more embodiments.

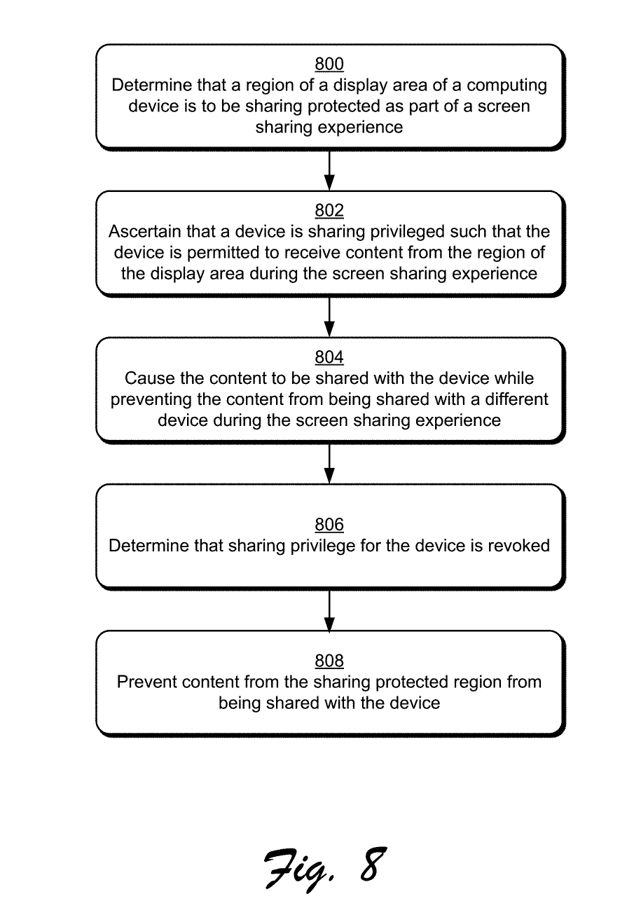

The following discussion describes some example procedures for content protection for a screen sharing experience in accordance with one or more embodiments. The example procedures may be employed in the environment 100 of FIG. 1, the system 800 of FIG. 8, and/or any other suitable environment. The procedures, for instance, represent example procedures for implementing the implementation scenarios described above. In at least some implementations, the steps described for the various procedures are implemented automatically and independent of user interaction. According to various implementations, the procedures may be performed locally (e.g., at the client device 102) and/or at a network-based service, such as the communication service 120.

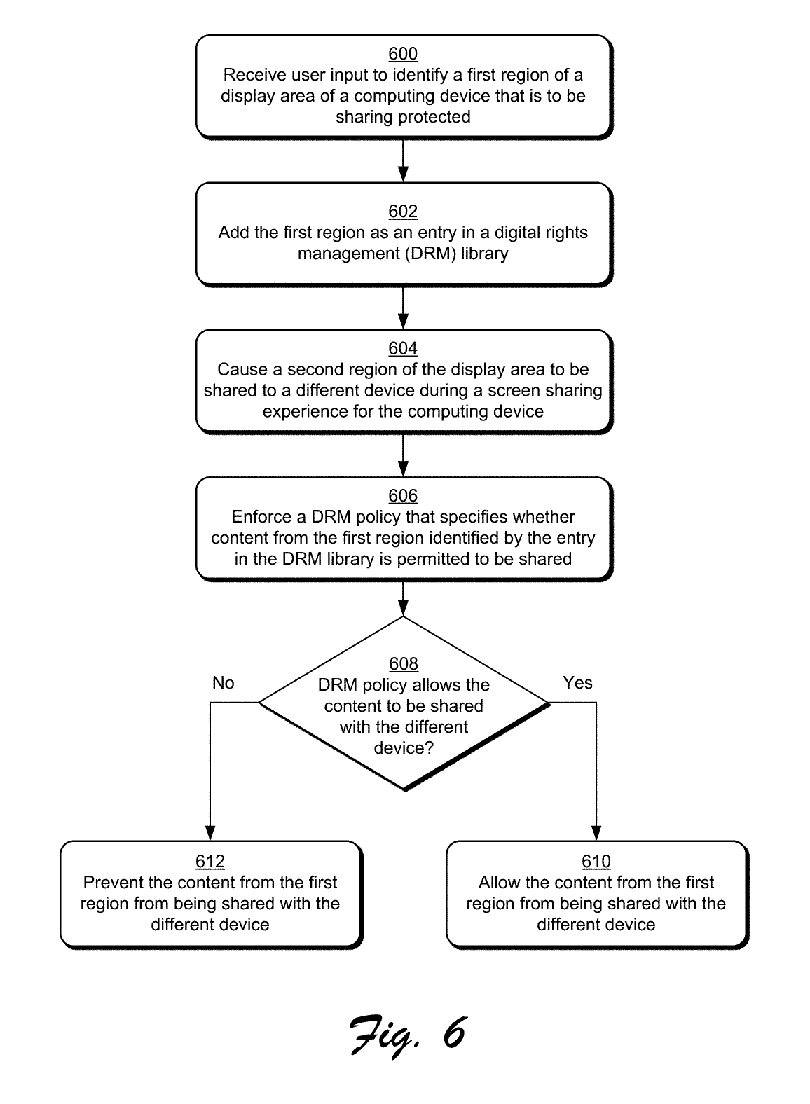

FIG. 6 is a flow diagram that describes steps in a method in accordance with one or more implementations. The method describes an example procedure for designating a sharing protected region in accordance with one or more implementations. In at least some implementations, the method may be performed at least in part at the client device 102 (e.g., by the communication client 110) and/or by the communication service 120.

Step 600 receives user input to identify a first region of a display area of a computing device that is to be sharing protected. A user, for instance, selects a particular region of a display area and/or a particular content type that is to be sharing protected. Example ways of designating a display region and/or particular content as sharing protected are discussed above.

Step 602 adds the first region as an entry in a digital rights management (DRM) library. For example, the communication client 110 interacts with the DRM module 126 to map the region into the DRM library 128. In at least one implementation, an identifier for the region is stored as an entry in the DRM library. The identifier can take various forms, examples of which are described in the implementation scenarios above.

Step 604 causes a second region of the display area to be shared to a different device during a screen sharing experience for the computing device. The screen sharing experience, for instance, is part of a real-time communication session that involves the computing device and the different device. Accordingly, a user of the computing device can activate a screen sharing mode that enables content from a portion of the display area to be shared with other devices involved in the communication session.

Step 606 enforces a DRM policy that specifies whether content from the region identified by the entry in the DRM library is permitted to be shared with the different device. A sharing policy 124, for instance, specifies conditions under which the content from the region is permitted to be shared, and other conditions under which the content from the region is not permitted to be shared. For example, the sharing policy may specify that when the computing device and/or the different device are located in a first location, the content is permitted to be shared, whereas when the computing device and/or the different device are located in a second location, the content is not permitted to be shared. Location may be determined in various ways, such as geographic location, enterprise location, network domain, and so forth.

In one or more implementations, sharing protection can be application-specific. For instance, if a user or other entity designates an application as sharing protected, the application can be catalogued in the DRM library 128 as sharing protected. The application, for example, is added as an entry in the DRM library 128. Thus, in at least some implementations, when a window or multiple windows for the application are generated at the client device 102, sharing protection is applied for the windows. A user, for example, need not specifically designate an application window as being sharing protected in order for a DRM policy to be enforced for the window. Further, sharing protection can be applied for application content even if the content is moved outside of a window for the application, such as if the content is copied and/or cut, and then pasted elsewhere. Thus, techniques for content protection for a screen sharing experience enable sharing policies to be enforced for application-specific content and elements however the content and elements are manifested.

Step 608 ascertains whether the DRM policy allows the content to be shared with the different device. The sharing module 122, for instance, determines whether the DRM module 126 indicates that a particular sharing policy 124 indicates that, based on a current condition (e.g., location, user ID, and so forth), the sharing policy 124 indicates that the content is permitted or not permitted to be shared with the different device.

If the DRM policy specifies that content from the region identified by the entry in the DRM library is permitted to be shared with the different device (“Yes”), step 610 allows the content to be shared with the different device. The sharing module 122, for instance, receives an indication from the DRM module 126 that the content is permitted to be shared. Accordingly, the communication client 110 causes the content to be communicated to the different device, such as part of a communication session.

If the DRM policy specifies that content from the region identified by the entry in the DRM library is not permitted to be shared with the different device (“No”), step 612 prevents content from the first region from being shared with the different device during the screen sharing experience. The sharing module 122, for instance, receives an indication from the DRM module 126 that the content is not permitted to be shared. For example, a particular sharing policy 124 indicates that based on a current condition, the content is not permitted to be shared to the different device. Thus, the sharing module 122 prevents the content from being communicated to the different device.

According to various implementations, the DRM module 126 maintains different sharing policies that are applied for content sharing. In at least some implementations, a particular sharing policy 124 may have designating exceptions, such as for devices and/or users that are specified as sharing privileged such that the devices/users are permitted to receive content that is sharing protected. Thus, sharing protection may be conditionally applied to allow content sharing under one set of conditions, but disallow content sharing under a different set of conditions.

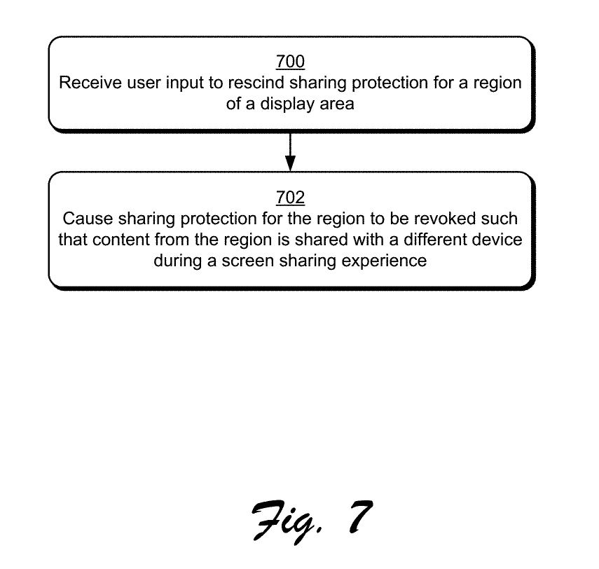

FIG. 7 is a flow diagram that describes steps in a method in accordance with one or more implementations. The method describes an example procedure for rescinding sharing protection in accordance with one or more implementations. In at least some implementations, the method may be performed at least in part at the client device 102 (e.g., by the communication client 110) and/or by the communication service 120. The method, for instance, describes an extension of the method described above with reference to FIG. 6.

Step 700 receives user input to rescind sharing protection for a region of a display area. The user, for instance, provides input to stop sharing protection for a particular region. With reference to the method described above, sharing protection may be rescinded for the first region.

Step 702 causes sharing protection for the region to be revoked such that content from the region is shared with a different device during a screen sharing experience. For example, with reference to the method described above, the further user input causes a sharing protection mode for the first region to be deactivated such content from the first region is shared with other devices participating in the screen sharing experience, such as other devices involved in a communication session. In at least one implementation, this causes a sharing policy 124 for the region to not be enforced.

According to one or more implementations, rescinding the sharing protection causes the DRM library 128 to be updated to indicate that the first region is not sharing protected. An identifier for the region, for instance, is removed from the DRM library 128. Alternatively, a status of the region can be updated in the DRM library 128 to indicate that the region is not sharing protected. Thus, sharing protection is not enforced for content displayed in the region.

FIG. 8 is a flow diagram that describes steps in a method in accordance with one or more implementations. The method describes an example procedure for designating a user as sharing privileged in accordance with one or more implementations. In at least some implementations, the method may be performed at least in part at the client device 102 (e.g., by the communication client 110) and/or by the communication service 120. The method, for instance, describes an extension of the methods described above with reference to FIGS. 6, 7.

Step 800 determines that a region of a display area of a computing device is to be sharing protected as part of a screen sharing experience. Generally, different ways of designating a region of a display area as sharing protected are described above. In at least one implementation, the screen sharing experience is part of a real-time communication session that involves multiple devices.

Step 802 ascertains that a device is sharing privileged such that the device is permitted to receive content from the region of the display area during the screen sharing experience. The device, for instance, is associated with an identity of a user that is designated as sharing privileged. For example, the privileged user is authenticated with the device such that the device is bound to an identity of the privileged user. Example ways of designating a user and/or device as sharing privileged are described above.

In an example implementation, an identity of the user and/or device is recorded in the DRM library 128 to enable the DRM module 126 and/or the communication client 110a to identify the user/device as sharing privileged.

Step 804 causes the content to be shared with the device while preventing the content from being shared with a different device during the screen sharing experience. For instance, when sharing protection is enforced for content from a sharing protected region, the DRM library 128 can be referenced to determine whether any users are designated as sharing privileged. When the user is identified as sharing privileged, sharing protected content is shared with the user's device during the screen sharing experience.

Step 806 determines that sharing privilege for the device is revoked. A user, for instance, performs an action to revoke a sharing privileged status of a user, such as removing the user from a set of sharing privileged users. In at least one implementation, this causes the DRM library 128 to be updated to indicate that the user is not sharing privileged, such as by removing an identity of the user from a set of sharing privileged users identified in the DRM library 128.

Step 808 prevents content from the sharing protected region from being shared with the device. The communication client 110 and/or the DRM module 126, for instance, enforce sharing protection for the content such that the content is not shared with the device during the screen sharing experience.

Generally, this procedure can be performed dynamically and in real time while a screen sharing experience (e.g., a communication session) is active. For instance, while the screen sharing experience is active, a sharing user can designate a different user as sharing privileged such that the different user's device receives sharing protected content for a period of time. Further, while the screen sharing experience is still active, the sharing user can revoke the sharing privileged status of the different user such that sharing protected content stops being shared with the different user.

According to implementations discussed herein, the procedures described above can be performed multiple times during a communication session to designate sharing protected regions of a display area, and to identity users that are sharing privileged.

Accordingly, techniques discussed herein provide a wide variety of scenarios and implementations for allowing some content to be shared during a screen sharing experience, while protecting other content from being shared during the experience. This enhances the ability of a user to share certain content during a screen sharing experience, while protecting other sensitive content during the experience.

Having discussed some example procedures, consider now a discussion of an example system and device in accordance with one or more embodiments.

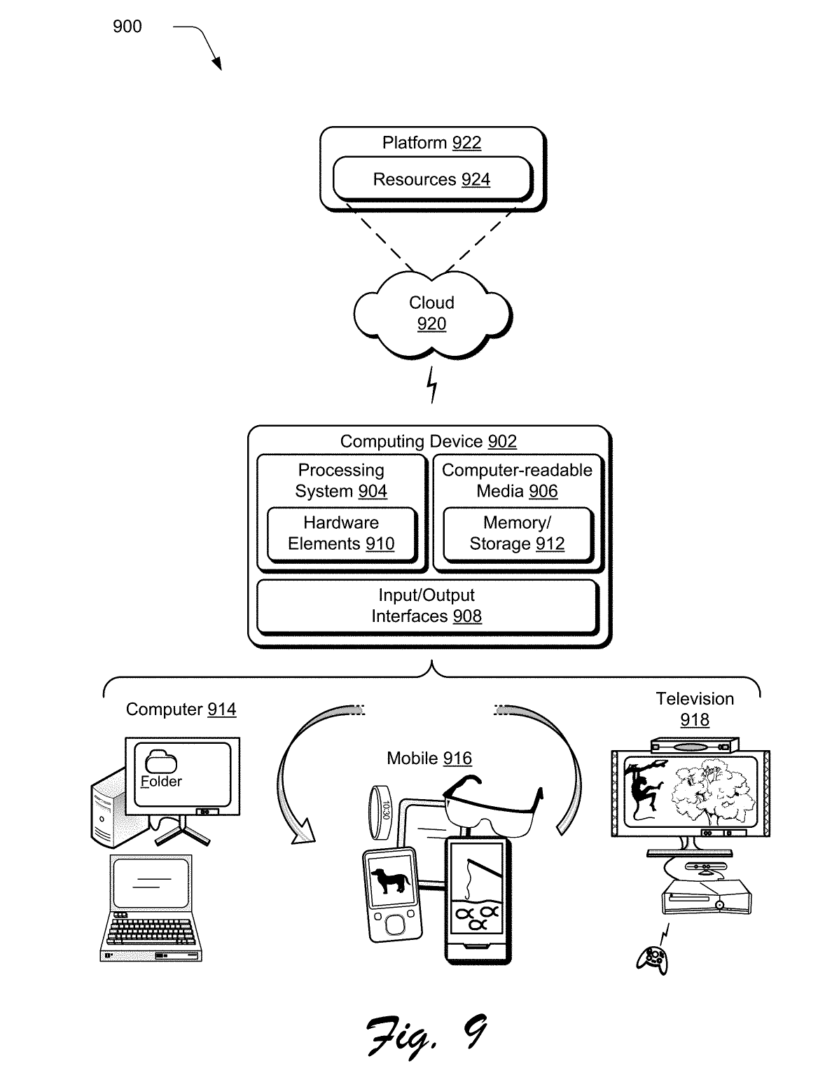

FIG. 9 illustrates an example system generally at 900 that includes an example computing device 902 that is representative of one or more computing systems and/or devices that may implement various techniques described herein. For example, the client device 92, the endpoint device 116, and/or the communication service 120 discussed above with reference to FIG. 1 can be embodied as the computing device 902. The computing device 902 may be, for example, a server of a service provider, a device associated with the client (e.g., a client device), an on-chip system, and/or any other suitable computing device or computing system.

The example computing device 902 as illustrated includes a processing system 904, one or more computer-readable media 906, and one or more Input/Output (I/O) Interfaces 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 906 is illustrated as including memory/storage 912. The memory/storage 912 represents memory/storage capacity associated with one or more computer-readable media. The memory/storage 912 may include volatile media (such as random access memory (RAM)) and/or nonvolatile media (such as read only memory (ROM), Flash memory, optical disks, magnetic disks, and so forth). The memory/storage 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “entity,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 910 and computer-readable media 906 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of modules that are executable by the computing device 902 as software may be achieved at least partially in hardware, e.g., through use of computer-readable storage media and/or hardware elements 910 of the processing system. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 900, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 902 may assume a variety of different configurations, such as for computer 914, mobile 916, and television 918 uses. Each of these configurations includes devices that may have generally different constructs and capabilities, and thus the computing device 902 may be configured according to one or more of the different device classes. For instance, the computing device 902 may be implemented as the computer 914 class of a device that includes a personal computer, desktop computer, a multi-screen computer, laptop computer, netbook, and so on.

The computing device 902 may also be implemented as the mobile 916 class of device that includes mobile devices, such as a mobile phone, portable music player, portable gaming device, a tablet computer, a wearable device, a multi-screen computer, and so on. The computing device 902 may also be implemented as the television 918 class of device that includes devices having or connected to generally larger screens in casual viewing environments. These devices include televisions, set-top boxes, gaming consoles, and so on.

The techniques described herein may be supported by these various configurations of the computing device 902 and are not limited to the specific examples of the techniques described herein. For example, functionalities discussed with reference to the sharing module 122, the DRM module 126, and/or the communication service 120 may be implemented all or in part through use of a distributed system, such as over a “cloud” 920 via a platform 922 as described below.

The cloud 920 includes and/or is representative of a platform 922 for resources 924. The platform 922 abstracts underlying functionality of hardware (e.g., servers) and software resources of the cloud 920. The resources 924 may include applications and/or data that can be utilized while computer processing is executed on servers that are remote from the computing device 902. Resources 924 can also include services provided over the Internet and/or through a subscriber network, such as a cellular or Wi-Fi network.

The platform 922 may abstract resources and functions to connect the computing device 902 with other computing devices. The platform 922 may also serve to abstract scaling of resources to provide a corresponding level of scale to encountered demand for the resources 924 that are implemented via the platform 922. Accordingly, in an interconnected device embodiment, implementation of functionality described herein may be distributed throughout the system 900. For example, the functionality may be implemented in part on the computing device 902 as well as via the platform 922 that abstracts the functionality of the cloud 920.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 90.

Techniques for content protection for a screen sharing experience are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

Implementations discussed herein include:

### EXAMPLE 1

A system for enforcing a content sharing policy to determine whether content is to be shared during a screen sharing experience, the system comprising: at least one processor; and one or more computer-readable storage media including instructions stored thereon that, responsive to execution by the at least one processor, cause the system perform operations including: receiving user input to identify a region of a display area of a computing device that is to be sharing protected; adding the region as an entry in a digital rights management (DRM) library; enforcing a DRM policy that specifies whether content from the region identified by the entry in the DRM library is permitted to be shared; and preventing content from the region from being shared with a different device during a screen sharing experience for the computing device in an event that the DRM policy specifies that the content from the region identified by the entry in the DRM library is not to be shared.

### EXAMPLE 2

A system as recited in example 1, wherein the user input comprises a drawing gesture that identifies the region of the display area.

### EXAMPLE 3

A system as recited in one or more of examples 1 or 2, wherein the user input comprises a user selection of a sharing protect control displayed as part of a graphical user interface (GUI) displayed in the region of the display area.

### EXAMPLE 4

A system as recited in one or more of examples 1-3, wherein the user input comprises input to specify a content type that is to be sharing protected.

### EXAMPLE 5

A system as recited in one or more of examples 1-4, wherein said adding comprises storing an identifier for the region in the DRM library, the identifier including screen coordinates for the region.

### EXAMPLE 6

A system as recited in one or more of examples 1-5, wherein the region is added based on an application associated with the region, and wherein said enforcing applies the DRM policy to application content for the application.

### EXAMPLE 7

A system as recited in one or more of examples 1-6, wherein said adding comprises storing an identifier for the region in the DRM library, the identifier including an application identifier for a graphical user interface (GUI) displayed in the region.

### EXAMPLE 8

A system as recited in one or more of examples 1-7, wherein the screen sharing experience comprises a real-time communication session that includes the computing device and the different device, and wherein the screen sharing experience enables content from a different region of the display area to be shared with the different device, while said preventing prevents the content from the region from being shared with the different device during the communication session.

### EXAMPLE 9

A system as recited in one or more of examples 1-8, wherein the screen sharing experience comprises a real-time communication session that includes the computing device and the different device, and wherein said receiving, said adding, and said enforcing are performed dynamically during the communication session.

### EXAMPLE 10

A system as recited in one or more of examples 1-9, wherein the operations further include: ascertaining that a further device is sharing privileged such that the further device is permitted to receive the content from the region of the display area during the screen sharing experience; and causing the content to be shared with the further device while preventing the content from being shared with the different device during the screen sharing experience.

### EXAMPLE 11

A computer-implemented method for enforcing a content sharing policy to determine whether content is to be shared during a screen sharing experience, the method comprising: receiving user input to identify a first region of a display area of a computing device that is to be sharing protected; adding the first region as an entry in a digital rights management (DRM) library; causing a second region of the display area to be shared to a different device during a screen sharing experience for the computing device; enforcing a DRM policy that specifies whether content from the first region identified by the entry in the DRM library is permitted to be shared; and preventing content from the first region from being shared with the different device during the screen sharing experience for the computing device in an event that the DRM policy specifies that the content from the first region identified by the entry in the DRM library is not to be shared.

### EXAMPLE 12

A method as described in example 11, wherein the user input comprises a user selection of a sharing protect control displayed as part of a graphical user interface (GUI) displayed in the first region of the display area.

### EXAMPLE 13

A method as described in one or of examples 11 or 12, wherein said adding comprises storing an identifier for the first region in the DRM library.

### EXAMPLE 14

A method as described in one or more of examples 11-13, wherein said adding comprises storing an identifier for the content in the DRM library.

### EXAMPLE 15

A method as described in one or more of examples 11-14, further comprising: ascertaining that a further device is sharing privileged such that the further device is permitted to receive the content from the region of the display area during the screen sharing experience; and causing the content to be shared with the further device while preventing the content from being shared with the different device during the screen sharing experience.

### EXAMPLE 16

A computer-implemented method for sharing protected content during a screen sharing experience, the method comprising: determining that a region of a display area of a computing device is to be sharing protected as part of a screen sharing experience; ascertaining that a device is sharing privileged such that the device is permitted to receive content from the region of the display area during the screen sharing experience; and causing the content to be shared with the device while preventing the content from being shared with a different device during the screen sharing experience.

### EXAMPLE 17

A method as described in example 16, further comprising receiving user input identifying a user of the device as sharing privileged, and wherein said ascertaining is responsive to said identifying.

### EXAMPLE 18

A method as described in one or more of examples 16 or 17, wherein the screen sharing experience comprises a real-time communication session, and wherein the method further comprises receiving user input identifying a user of the device as sharing privileged, said receiving occurring dynamically while the communication session is in progress.

### EXAMPLE 19

A method as described in one or more of examples 16-18, further comprising receiving user input identifying a user of the device as sharing privileged, the user input comprising a user interaction with an icon that represents the user of the device, and wherein said ascertaining is responsive to said identifying.

### EXAMPLE 20

A method as described in one or more of examples 16-19, further comprising: receiving further user input revoking the user of the device as sharing privileged; and preventing the content from being shared with the device in response to the further user input.

What is claimed is:

1. A system comprising:
at least one processor; and
one or more computer-readable storage media including instructions stored thereon that, responsive to execution by the at least one processor, cause the system perform operations including:
receiving user input to identify a region of a display area of a computing device that is to be sharing protected;
adding the region as an entry in a digital rights management (DRM) library;
enforcing a DRM policy that specifies whether content from the region identified by the entry in the DRM library is permitted to be shared; and
preventing content from the region from being shared with a different device during a screen sharing experience for the computing device in an event that the DRM policy specifies that the content from the region identified by the entry in the DRM library is not to be shared.

2. A system as recited in claim 1, wherein the user input comprises a drawing gesture that identifies the region of the display area.

3. A system as recited in claim 1, wherein the user input comprises a user selection of a sharing protect control displayed as part of a graphical user interface (GUI) displayed in the region of the display area.

4. A system as recited in claim 1, wherein the user input comprises input to specify a content type that is to be sharing protected.

5. A system as recited in claim 1, wherein said adding comprises storing an identifier for the region in the DRM library, the identifier including screen coordinates for the region.

6. A system as recited in claim 1, wherein the region is added based on an application associated with the region, and wherein said enforcing applies the DRM policy to application content for the application.

7. A system as recited in claim 1, wherein said adding comprises storing an identifier for the region in the DRM library, the identifier including an application identifier for a graphical user interface (GUI) displayed in the region.

8. A system as recited in claim 1, wherein the screen sharing experience comprises a real-time communication session that includes the computing device and the different device, and wherein the screen sharing experience enables content from a different region of the display area to be shared with the different device, while said preventing prevents the content from the region from being shared with the different device during the communication session.

9. A system as recited in claim 1, wherein the screen sharing experience comprises a real-time communication session that includes the computing device and the different device, and wherein said receiving, said adding, and said enforcing are performed dynamically during the communication session.

10. A system as recited in claim 1, wherein the operations further include:
ascertaining that a further device is sharing privileged such that the further device is permitted to receive the content from the region of the display area during the screen sharing experience; and
causing the content to be shared with the further device while preventing the content from being shared with the different device during the screen sharing experience.

11. A computer-implemented method, comprising:
receiving user input to identify a first region of a display area of a computing device that is to be sharing protected;
adding the first region as an entry in a digital rights management (DRM) library;
causing a second region of the display area to be shared to a different device during a screen sharing experience for the computing device;
enforcing a DRM policy that specifies whether content from the first region identified by the entry in the DRM library is permitted to be shared; and
preventing content from the first region from being shared with the different device during the screen sharing experience for the computing device in an event that the DRM policy specifies that the content from the first region identified by the entry in the DRM library is not to be shared.

12. A method as described in claim 11, wherein the user input comprises a user selection of a sharing protect control displayed as part of a graphical user interface (GUI) displayed in the first region of the display area.

13. A method as described in claim 11, wherein said adding comprises storing an identifier for the first region in the DRM library.

14. A method as described in claim 11, wherein said adding comprises storing an identifier for the content in the DRM library.

15. A method as described in claim 11, further comprising:
ascertaining that a further device is sharing privileged such that the further device is permitted to receive the content from the region of the display area during the screen sharing experience; and
causing the content to be shared with the further device while preventing the content from being shared with the different device during the screen sharing experience.

16. A computer-implemented method, comprising:
determining that a region of a display area of a computing device is to be sharing protected as part of a screen sharing experience;
ascertaining that a device is sharing privileged such that the device is permitted to receive content from the region of the display area during the screen sharing experience; and
causing the content to be shared with the device while preventing the content from being shared with a different device during the screen sharing experience.

17. A method as described in claim 16, further comprising receiving user input identifying a user of the device as sharing privileged, and wherein said ascertaining is responsive to said identifying.

18. A method as described in claim 16, wherein the screen sharing experience comprises a real-time communication session, and wherein the method further comprises receiving user input identifying a user of the device as sharing privileged, said receiving occurring dynamically while the communication session is in progress.

19. A method as described in claim 16, further comprising receiving user input identifying a user of the device as sharing privileged, the user input comprising a user interaction with an icon that represents the user of the device, and wherein said ascertaining is responsive to said identifying.

20. A method as described in claim 16, further comprising:
receiving further user input revoking the user of the device as sharing privileged; and
preventing the content from being shared with the device in response to the further user input.
